(19) United States
(12) Patent Application Publication
(10) Pub. No.: US 2021/0150404 A1
(43) Pub. Date: May 20, 2021

(54) METHOD AND DEVICE FOR FINDING HAMILTONIAN EXCITED STATES

(71) Applicant: QUNASYS INC., Tokyo (JP)

(72) Inventors: Ken NAKANISHI, Tokyo (JP); Kosuke MITARAI, Tokyo (JP); Yuya NAKAGAWA, Tokyo (JP)

(73) Assignee: QUNASYS INC., Tokyo (JP)

(21) Appl. No.: 17/160,143

(22) Filed: Jan. 27, 2021

Related U.S. Application Data
(63) Continuation of application No. PCT/JP2019/041395, filed on Oct. 21, 2019.

(30) Foreign Application Priority Data
Nov. 4, 2018 (JP) 2018-207825
Jul. 12, 2019 (JP) 2019-130414

(51) Int. Cl. G06N 10/00; G06F 30/20

(52) U.S. Cl. CPC G06N 10/00; G06F 2111/10; G06F 30/20

(57) ABSTRACT

A classical computer decides a set of k+1 mutually orthogonal initial states for a Hamiltonian H of qubit number n, wherein k is an integer from 0 to 2n−1, and n is a positive integer. The classical computer decides a first quantum circuit U (θ) that is a unitary quantum circuit of qubit number n. The classical computer decides a first parameter θi and generating quantum computation information for executing the first quantum circuit U (θi) on a qubit cluster of a quantum computer. The classical computer stores a computation result of respective quantum computations based on the quantum computation information for each of the set of initial states. The classical computer computes an expected value sum L1 (θi) of the Hamiltonian H based on the computation results for the initial states. The classical computer stores a value θ* when a convergence condition has been satisfied.

### CROSS-REFERENCE TO RELATED APPLICATIONS

This application is a continuation application of International application Serial No. PCT/JP2019/041395 filed Oct. 21, 2019, which, in turn, claims priority to Japanese application Serial No. 2018-207825 filed Nov. 4, 2018 and Japanese application Serial No. 2019-130414 filed Jul. 12, 2019, the disclosures of which are hereby incorporated in their entirety by reference herein.

### TECHNICAL FIELD

Technology disclosed herein relates to a method, a device, and a recording medium for finding excited states of a Hamiltonian.

### BACKGROUND

Great expectations are building that when quantum computers start to exceed 100 to 150 qubits, they will be able to perform simulations that hitherto have been difficult or impossible to perform by simulation on a super computer.

As the practical implementation of quantum computers progresses, as well as progress being made in research into the hardware for quantum computer, progress is also being made in research into algorithms to execute quantum computations using such hardware.

Such algorithm research started by expressing the problem to be solved by simulation as a Hamiltonian, and finding the ground state of the Hamiltonian. Now attempts are being made to not only find the ground state, but to also find the excited states thereof. Although not limited thereto, the excited states are useful to understand the processes of a chemical reaction, in the analysis of light-emitting phenomena (phosphorescence, fluorescence, and so on), and in the design of molecules exhibiting such light-emitting phenomena.

For example, “Variational Quantum Computation of Excited States”, O. Higgott, D. Wang, and S. Brierley, 2018, arXiv:1805.08138 discloses a method employed in a hybrid system, which combines a quantum computer and a classical computer, to find excited states by extending a variational quantum eigensolver (VQE), which is a known method for finding the ground state of a Hamiltonian.

### Related Non Patent Document

Non Patent Document 1: “Variational Quantum Computation of Excited States”, O. Higgott, D. Wang, and S. Brierley, 2018, arXiv:1805.08138

### SUMMARY

An aspect of technology disclosed herein is a method for finding excited states of a Hamiltonian. The method causing a classical computer to execute a process comprising: deciding a set of k+1 mutually orthogonal initial states for a Hamiltonian H of qubit number n, wherein k is an integer from 0 to 2ⁿ⁻¹, and n is a positive integer; deciding a first quantum circuit U (θ) that is a unitary quantum circuit of qubit number n; deciding a first parameter θᵢ and generating quantum computation information for executing the first quantum circuit U (θᵢ) on a qubit cluster of a quantum computer; storing a computation result of respective quantum computations based on the quantum computation information for each of the set of initial states; computing an expected value sum L₁(θᵢ) of the Hamiltonian H expressed by Equation (1) based on the computation results for the initial states; and changing the first parameter θᵢ in a direction in which the sum approaches a minimum value and storing a value θ* when a convergence condition has been satisfied.

L₁(θᵢ)=Σⱼ₌₀^{k}wⱼ<ψⱼ(θi)|H|ψⱼ(θᵢ)> (1)

Wherein |ψⱼ(θᵢ)> is a quantum state after executing the first quantum circuit (θᵢ) for a j^{th} initial state, and wⱼ is a positive coefficient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating a hybrid system according to a first exemplary embodiment of technology disclosed herein.

FIG. 2 is a diagram illustrating a flow of a method to identify excited states according to the first exemplary embodiment of technology disclosed herein.

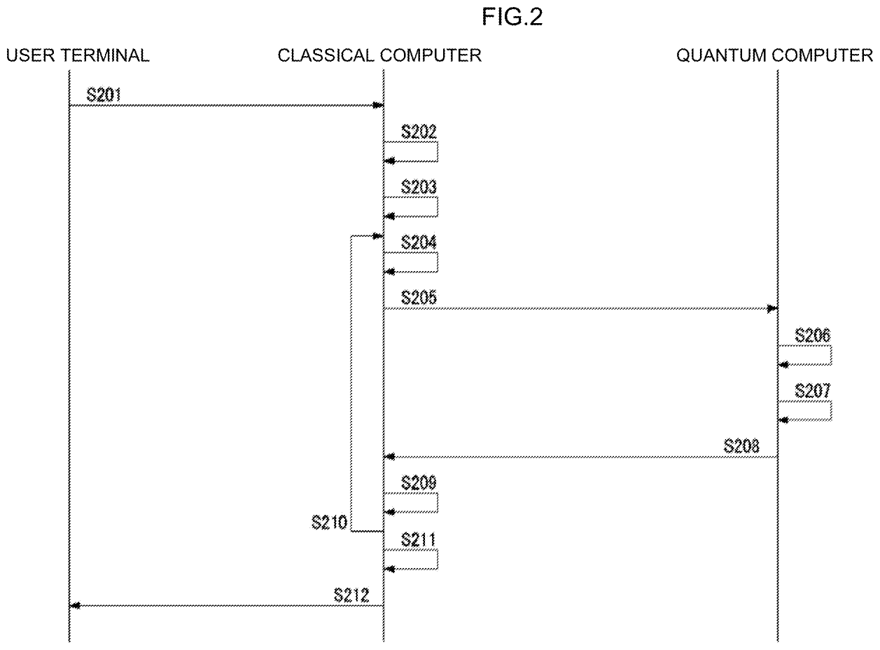

FIG. 3 is a diagram illustrating a flow of a method to identify excited states according to a second exemplary embodiment of technology disclosed herein.

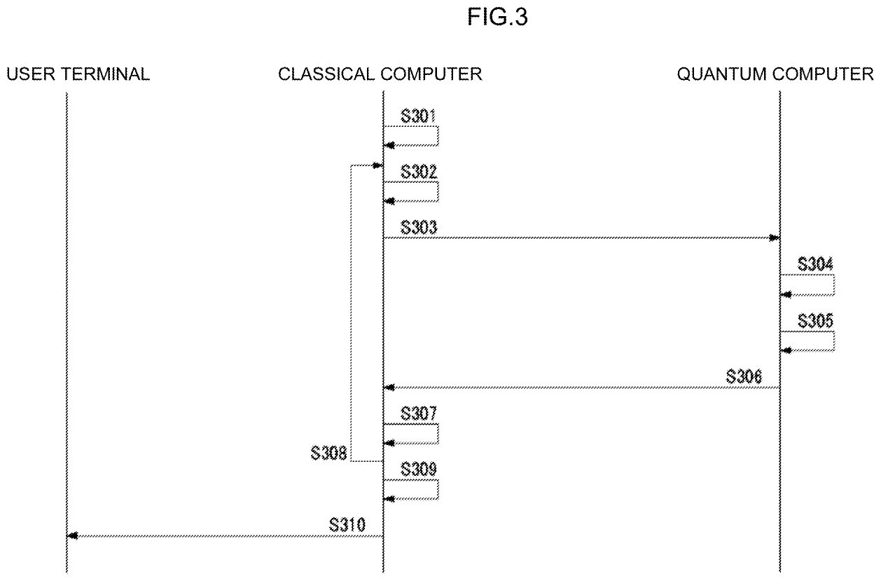

FIG. 4 is a diagram schematically illustrating an example of a second quantum circuit V (φ) in a second exemplary embodiment of technology disclosed herein.

FIG. 5 is a diagram illustrating an example of a first quantum circuit U (θ) and the second quantum circuit V (φ) illustrated in FIG. 4.

FIG. 6 is a diagram illustrating an optimization process for a first parameter θ.

FIG. 7 is a diagram illustrating an optimization process for a second parameter φ.

### DETAILED DESCRIPTION

Detailed explanation follows regarding exemplary embodiments of technology disclosed herein, with reference to the drawings.

### First Exemplary Embodiment

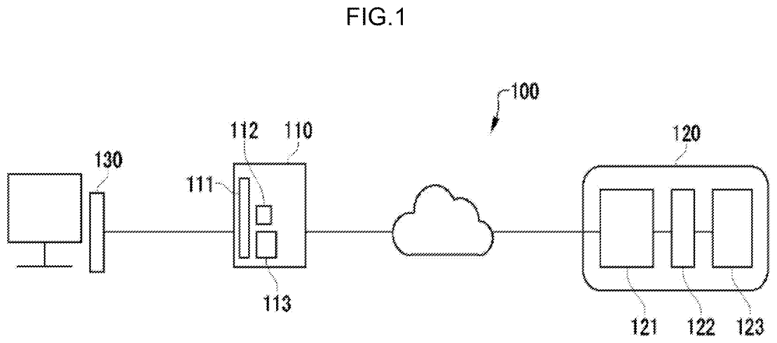

FIG. 1 illustrates a hybrid system according to a first exemplary embodiment of technology disclosed herein. A hybrid system 100 includes a classical computer 110 and a quantum computer 120. The classical computer 110 and the quantum computer 120 are, for example, connected together over a computer network such as an IP network. Although cases in which both the classical computer 110 and the quantum computer 120 are administered by a single organization are also conceivable, the following explanation concerns an example in which the classical computer 110 and the quantum computer 120 are administered by separate organizations, and in which overall computation progresses by the quantum computer 120 performing required quantum computations in response to requests from the classical computer 110, and then returning to the classical computer 110 the computation results of such quantum computations.

The classical computer 110 includes a communication section 111 such as a communication interface, a processing section 112 such as a processor, a CPU, or the like, and a storage section 113 including a storage device such as memory or a hard disk, or a storage medium. The classical computer 110 may be configured to perform various processing by executing a program, and the classical computer 110 may also include one or plural devices or servers. The program may be one program, or may include plural programs, and may be configured as a non-transitory program product recorded on a computer-readable storage medium.

First, the classical computer 110 receives problem information relating to a problem to be solved by quantum computing from a user terminal 130 of a user (S201). Examples of such a problem include the energy of a k^{th} excited state of a molecule, and in particular of a light-emitting molecule such as a molecule including an aromatic ring, or the energy of the k^{th} excited state when a catalyst is in close proximity to the target molecule (wherein k is an integer of 1 or greater). In cases in which such a problem can be expressed by the user as a Hamiltonian, the Hamiltonian may be received as problem information. The user terminal 130 may transmit the problem information over a computer network such as an IP network to the classical computer 110 or to a storage medium or storage device capable of accessing the classical computer 110. Another conceivable approach is to store the problem information on a storage medium or storage device and pass the storage medium or storage device to an administrator of the classical computer 110 for the administrator to input the problem information to the classical computer 110 using the storage medium or storage device.

The classical computer 110 converts the problem information to a quantum computable Hamiltonian H, as required. In cases in which the qubit number available to the classical computer 110 in the quantum computer 120 is N (wherein N is an integer), as an example, the qubit number n of the Hamiltonian H the classical computer 110 is able to process may conceivably be N or lower. However, there is no limitation to the qubit number n of the Hamiltonian H being the qubit number N of the quantum computer 120 or lower, and there may be cases in which the qubit number n of the Hamiltonian H is a value exceeding N. Even in cases in which the problem to be solved is in the form of a Hamiltonian, there may be cases in which the Hamiltonian H needs to be converted into a format more easily handled by a quantum computer using Jordan-Wigner conversion or the like. Moreover, in cases in which the problem to be solved is not provided as a Hamiltonian, there may be a need for conversion to a Hamiltonian representation. Moreover, on receipt from the user terminal 130 of a k value for the k^{th} excited state the user wishes to find, the classical computer 110 may employ this k value. However, when the k value is not received, processing may proceed to quantum computation by taking any integer from 1 to 2ⁿ⁻¹ as the k value.

Next, the classical computer 110 decides a first quantum circuit U (θ) of qubit number n (S202). Any given quantum circuit that is a unitary quantum circuit may be determined as the first quantum circuit U (θ), and this may, for example, be a quantum circuit according to the Hamiltonian H. The first quantum circuit U (θ) is also sometimes referred to as a variational quantum circuit due being parameterized. The first quantum circuit U (θ) may be stored in advance in the storage section 113 or in a storage medium or storage device accessible to the classical computer 110, and may be decided by identifying which. In cases in which a circuit according to the Hamiltonian H is employed, the first quantum circuit U (θ) may be decided by setting the Hamiltonian H based on the problem information and then generating a circuit appropriate to the Hamiltonian H.

The classical computer 110 also decides a set of k+1 initial states, which are mutually orthogonal initial states and of qubit number n (S203). For example, |0000>, |0001>, and |0010> may be used as the set of initial states in a case in which n=4 and k=2. The set of initial states may be decided by selecting, from out of quantum states stored in the storage section 113 or in the storage medium or storage device accessible to the classical computer 110, according to the Hamiltonian H qubit number n and the energy excitation level k to be found. Alternatively, the set of initial states may be decided by generation according to the Hamiltonian H qubit number n and the energy excitation level k to be found.

The classical computer 110 then decides a first parameter θᵢ of the first quantum circuit U (θ) (wherein i is an integer of 1 or greater) (S204). For example, the first parameter θ₁ is conceivably a random number or pseudorandom number in a fixed range, such as from 0 up to but not including 2π. Note although explanation here is of a case in which the first quantum circuit U (θ) is decided, then the initial states are decided, and then the first parameters θᵢ are decided, in this sequence, a different sequence may be employed to this sequence.

The classical computer 110 then transmits information for quantum computation to the quantum computer 120 (S205). In a case in which i=1, the quantum computation information includes initial setting information to realize each of the set of initial states in a qubit cluster 123 of the quantum computer 120, and includes quantum gate information to execute the first quantum circuit U (θᵢ) in the qubit cluster 123. The quantum computation information for cases in which i≥2 may contain the quantum gate information alone. The initial setting information may be transmitted at the same time as the quantum computation information or may be transmitted separately thereto, either before or after.

As an example, based on the quantum computation information transmitted from the classical computer 110, the quantum computer 120 generates an electromagnetic wave for irradiating at least one qubit out of the qubit cluster 123. The quantum circuit is executed by performing the electromagnetic wave irradiation. In the example illustrated in FIG. 1, the quantum computer 120 includes a mediation device 121 to perform communication with the classical computer 110, an electromagnetic wave generation device 122 to generate electromagnetic waves in response to requests from the mediation device 121, and the qubit cluster 123 subjected to irradiation of electromagnetic waves from the electromagnetic wave generation device 122. In the present specification, the “quantum computer” refers to a computer that performs at least some computation with qubits, rather than denoting a computer that does not perform any computation using classical bits at all.

The mediation device 121 is a classical computer that performs computation using classical bits, and may also perform some or all of the processing that is described in the present specification as being performed by the classical computer 110, on behalf thereof. For example, when the first quantum circuit U (θ) has been stored or decided, the quantum gate information to execute the first quantum circuit U (θᵢ) on the qubit cluster 123 may be generated in the mediation device 121 in response to receipt of the first parameter θi as the quantum computation information. Moreover, the initial setting information to implement the set of initial states in the qubit cluster 123 may be generated in the mediation device 121 in response to receipt of information expressing the set of initial states as the quantum computation information.

Based on the received quantum computation information, the quantum computer 120 executes the quantum computation (S206). Initial settings based on the initial setting information are needed for the qubit cluster 123 in order to execute the quantum computation. In a case in which n=4 and k=2, for example |0000>, |0001>, and |0010> may be used as the set of initial states, and prior to executing the first quantum circuit U (θᵢ) for the respective initial states, the qubit cluster 123 executes a gate operation such as an X gate or the like so as to achieve the respective initial states. Since executable gate operations are different according to the specifics of the quantum computer 120, the initial setting information and the quantum gate information are split up or transformed as required into gate operations or combinations of quantum gates executable by the quantum computer 120 being employed. The information after being split up or transformed may be used as the initial setting information and the quantum gate information. Alternatively, the information prior to being split up or transformed may be used as the initial setting information and the quantum gate information, and then split up or transformed in the quantum computer 120 as required.

The respective gate operations are then converted into corresponding electromagnetic waveforms, and the qubit cluster 123 is irradiated by the electromagnetic wave generation device 122 with the generated electromagnetic waves. The conversion to electromagnetic waveforms may be performed by the electromagnetic wave generation device 122, or may be performed by the mediation device 121. Alternatively, such conversion may be performed in the classical computer 110, and the quantum computation information generated in electromagnetic waveform format. Although an example is explained in which the quantum circuit is executed by irradiation with electromagnetic waves, this does not exclude execution of the quantum circuit using a different method.

The quantum computer 120 then measures a computation result of the quantum computation (S207). The quantum computation is executed and measured for each initial state in the set of initial states. For example, bit strings such as those in the table below may be obtained as measurement results. This example illustrates results for when electromagnetic wave irradiation and measurement is repeatedly performed for n=4 and k=2. The number of repetitions may be decided by the classical computer 110 and transmitted to the quantum computer 120 as part of the quantum computation information, or separately to the quantum computation information. Alternatively, the number of repetitions may be decided by the quantum computer 120 or the mediation device 121 thereof.

TABLE 1

| | \|0000> | \|0001> | \|0010> |
|---|---|---|---|
| 0000 | 10 | 11 | 76 |
| 0001 | 50 | 14 | 22 |
| 0010 | 14 | 100 | 17 |
| 0011 | 12 | 45 | 33 |
| 0100 | 85 | 10 | 20 |
| . | . | . | . |
| . | . | . | . |
| . | . | . | . |

The classical computer 110 receives and stores the measurement results of the quantum computation according to the quantum computation information from the quantum computer 120 (S208). An expected value for the energy of the Hamiltonian H is then computed by performing statistical processing on the measurement results for each of the initial states, and an expected value sum L₁(θᵢ) is computed for the set of initial states (S209). A quantum state following execution of the first quantum circuit U (θᵢ) for a j^{th} initial state (wherein j is an integer from 0 to k) out of a set of the k+1 initial states is denoted by |ψⱼ(θᵢ)>, and the expected value sum L₁(θᵢ) can be expressed using the following Equation. Note that wⱼ is a positive coefficient.

L₁(θᵢ)=Σⱼ₌₀^{k}wⱼ<ψⱼ(θi)|H|ψⱼ(θᵢ)>

Next, when i=1, i is incremented to update the first parameter θᵢ, and the expected value sum L₁(θ₂) is computed for this first parameter θ₂. When i=2 or greater, convergence determination is performed as to whether or not the expected value sum L₁(θ₂) has converged (S210). For example, in order to obtain a value of 0, that minimizes L₁(θᵢ), or a value close thereto, determination that convergence has occurred can be made when |L₁(θᵢ₊₁)|L₁(θᵢ)<ε is satisfied, wherein ε as a threshold. In cases in which there is no convergence, i is incremented to update the first parameter θᵢ, and the computation of the expected value sum is repeated. The first parameter θᵢ may be decided using an optimization algorithm such as the Nelder-Mead method, or alternatively θᵢ may be moved randomly without relying on an optimization method, and repeated attempts performed until the cost function L₁(θᵢ) reaches a desired value, for example a minimum value.

Note that changing the first parameter θᵢ so as to make the expected value sum L₁(θᵢ) approach a minimum value is synonymous with appending a negative sign to the expected value and changing the first parameter θᵢ so as to make the expected value sum L₁(θᵢ) approach a maximum value thereof.

The classical computer 110 stores θᵢ for when the expected value sum L₁(θᵢ) converges as an optimal value θ* of the first parameter θᵢ(S211).

The expected value computation for each of the initial states, the expected value sum computation, and the convergence determination that have been described above as being performed by the classical computer 110, may alternatively be performed on its behalf by the mediation device 121 of the quantum computer 120.

In consideration that the first quantum circuit U (θᵢ) has is a unitary quantum circuit, minimizing the expected value sum L₁(θᵢ) means that the respective quantum states |ψⱼ(θ*)> are mutually orthogonal to each other, and that each is expressed by a linear combination of the Hamiltonian H states from a ground state |g> to the k^{th} excited state |eₖ>. This is because the L₁(θᵢ) would have to be a larger value than the minimum value if quantum states of the k+1^{th} excited state |eₖ₊₁> or greater were to be included.

It is apparent that, for example, in a case in which wₖ is ½ and from w₀ to wₖ₋₁ is 1, then the first quantum circuit U (θᵢ) is optimized so as to give the greatest energy expected value with the smallest coefficients for |ψₖ(θᵢ)>, and |ψₖ(θ*)>=|eₖ>. Setting a coefficient wₛ (wherein s is an integer from 0 to k) for coefficient wⱼ so as to be smaller than the other coefficients wⱼ(wherein j≠s) in this manner, enables a quantum state |ψₛ(θᵢ)> corresponding to this coefficient to be optimized for the k^{th} excited state.

As another example, it is also apparent that finding wⱼ<wₖi achieves |wⱼ(θ*)>|eⱼ>. Arranging the coefficients wⱼ in sequence and taking the smaller value therefor enables the quantum state |wⱼ(θᵢ)> corresponding to the j^{th} coefficient to be optimized for the j^{th} excited state. Conversely, arranging the coefficients wⱼ in sequence and taking the larger value therefor enables the quantum state wⱼ(θᵢ)> corresponding to the j^{th} coefficient to be optimized for the (k−j)^{th} excited state.

In cases in which the k^{th} excited state |eₖ> is obtained as in this example, the classical computer 110 is able to transmit solution information to the user terminal 130, relating to the solution of a problem the user of the user terminal 130 wishes to solve (S212). Information relating to the k^{th} excited state is included in the solution information, and more specifically the solution information may include the expected value of the Hamiltonian H for the k^{th} excited state. The solution information may also include a measurement result of the k^{th} excited state or information corresponding thereto. The solution information may also include a probability of transition between the k^{th} excited state and an m^{th} excited state (wherein 0≤m<k), the electric susceptibility of molecules computed based on this transition probability, or the like.

Another conceivable example of application of a method according to the present exemplary embodiment is to employ a quantum circuit to generate all excited states for the first quantum circuit U (θᵢ) up to the k^{th} excited state described above so as to simulate time evolution under the Hamiltonian H.

In the present exemplary embodiment, identification of any given k^{th} excited state of the Hamiltonian H of qubit number n can be performed in a short time with a small qubit number by optimizing the single parameter of the first parameter θᵢ. In Non-Patent Document 1, the qubit number of the quantum computer 120 needs to be 2n, whereas the present exemplary embodiment enables this demand to be halved in number to n. The inventors simulated the quantum computer 120 using a classical computer for the comparatively small qubit number n=4 and verified the present exemplary embodiment. Logically it is reasonable to expect that were the quantum computer 120 to actually be employed instead of simulated then similar results would be obtained, and moreover, it is logical that similar results would still be obtained for a qubit number n of 100 or greater, or of 150 or greater.

Although the foregoing explanation anticipates a case in which the classical computer 110 and the quantum computer 120 are administered by different organizations, for cases in which the classical computer 110 and the quantum computer 120 are administered by the same organization, there is no longer a need to transmit the quantum computation information from the classical computer 110 to the quantum computer 120, or to transmit the measurement results from the quantum computer 120 to the classical computer 110. This means that the role of the classical computer 110 in the foregoing explanation may conceivably be undertaken by the mediation device 121 of the quantum computer 120.

Please note that in the present specification, unless the word “solely” is used, as in “based solely on xx”, “according solely to xx”, or “solely in the case of xx”, this should be deemed to mean that consideration of other additional information may also be anticipated. Moreover, please note that wording such as “in the case of A, then B” should be deemed not to mean that “B is always be true in the case of A”, unless clearly stated as such.

Moreover, in the interest of clarification please note that suppose there is an aspect in which an operation different to the operations described in the present specification is performed in a method, program, terminal, device, server, or system (hereafter “method or the like”), the aspects of the technology disclosed herein concern operations the same as operations described in the present specification, and the additional presence of the operation different to the operations described in the present specification does not cause the method or the like to fall outside the scope of the aspects of the technology disclosed herein.

Not that the various alternatives discussed in the first exemplary embodiment may similarly be applied to the second exemplary embodiment or the third exemplary embodiment.

### Second Exemplary Embodiment

In the first exemplary embodiment, when the coefficients wⱼ are all set to the same value, although |ψⱼ(θ*)> can be expressed by a linear combination of states of the Hamiltonian H from the ground state |g> to the k^{th} excited state |e^{k}>, these are intermingled states. |ψⱼ(θ*)> obtained by optimizing the first parameter θᵢ can be understood to be confined in an extensible subspace of k+1 quantum states from out of 2ⁿ mutually orthogonal quantum states that are possible quantum states for a qubit number n. In cases in which the coefficients wⱼ are all set to the same value, the second exemplary embodiment is able to find the k^{th} excited state in this subspace by introducing a second quantum circuit V (φ).

After obtaining the optimal value θ* of the first parameter θi, the classical computer 110 decides the second quantum circuit V (φ) (S301). The second quantum circuit V (φ) is one in which a set of initial states described above are intermingled, in other words the respective initial states are transformed into a quantum state in space as expressed by a linear combination of these initial states. The second quantum circuit V (φ) may be referred to as a variational quantum circuit due to being parameterized. For example, in a case in which n=4 and k=3, the set of initial states for a qubit number 4 are respectively expressed by bit strings |0000>, |0001>, |0010>, |0011> filling from the lowest order bit, and the second quantum circuit V (φ) may be thought of as being a circuit operated solely by filling the two lowest order bits. More generally, the second quantum circuit V (φ) may be thought of as operating solely in a set of k+1 initial states.

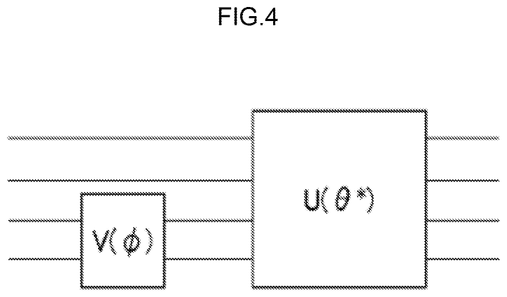

FIG. 4 schematically illustrates an example of the first quantum circuit U (θ) and the second quantum circuit V (φ). The second quantum circuit V (φ) may be stored in the storage section 113 or in a storage medium or storage device accessible to the classical computer 110, and may be decided by identifying which.

Next, the classical computer 110 decides a second parameter φᵢ(wherein i is an integer of 1 or greater) (S302). For example, the second parameter (pi may be a random number or pseudorandom number in a fixed range, such as from 0 up to but not including 2π. Note that although explanation is given regarding a case in which the second quantum circuit V (φ) is decided, and then the second parameter φᵢ is decided, in this sequence, a different sequence may be employed to this sequence.

The classical computer 110 then transmits quantum computation information to the quantum computer 120, similarly to in the first exemplary embodiment (S303). The point of difference here is that the information transmitted as quantum gate information includes information to execute the second quantum circuit V (φᵢ) in the qubit cluster 123 in addition to the information to execute the optimized first quantum circuit U (θ*) in the qubit cluster 123, and also in the point that the information transmitted as the initial setting information may include information to realize a given s^{th} initial state (wherein s is an integer from 0 to k) out of the set of initial states in the qubit cluster 123 of the quantum computer 120.

Based on the received quantum computation information, the quantum computer 120 executes the quantum computation for the s^{th} initial state (S304), and measures the result of the quantum computation (S305). The point that the electromagnetic wave irradiation and measurements are repeated, and the point that there is no limitation to electromagnetic wave irradiation, are similar to in the first exemplary embodiment.

The classical computer 110 then receives and stores the computation result of the quantum computation according to the quantum computation information from the quantum computer 120 (S306). The classical computer 110 then computes an energy expected value L₂(φᵢ) of the Hamiltonian H by performing statistical processing on the measurement results for the s^{th} initial state (S307). The quantum state after executing the first quantum circuit U (θ*) and the second quantum circuit V (φᵢ) for the given δ^{th} initial state is denoted |ψₛ(φᵢ)>, and the expected value L₂(φᵢ) may be expressed by the following Equation.

L₂(ϕᵢ)=−<ψₛ(ϕᵢ)|H|ψₛ(ϕᵢ)>

Next, when i=1, i is incremented to update the first parameter θᵢ, and the expected value L₂(φ₂) is computed for this second parameter φ₂. When i=2 or greater, convergence determination is performed as to whether or not the expected value L₂(φ₂) has converged (S308). The convergence determination may be performed in a similar manner to in the first exemplary embodiment.

The classical computer 110 stores φᵢ at the convergence of the expected value L₂(φᵢ) as an optimal value φ* of the second parameter φᵢ(S309).

The expected value computation and the convergence determination performed for the s^{th} initial state that have been described above as being performed by the classical computer 110 may alternatively be performed on its behalf by the mediation device 121 of the quantum computer 120.

Minimizing the expected value L₂(φᵢ) means that quantum states |ψⱼ(θ*)> from executing the first quantum circuit U (θ*) for the initial states are mutually orthogonal to each other and that each is expressed by a linear combination of the Hamiltonian H states from the ground state g> to the k^{th} excited state |eₖ>. Considering that the second quantum circuit V (φᵢ) has intermingled initial states, this means that |ψₛ(θ*)> is the k^{th} excited state |eₖ>. This is because L₂(φᵢ) would have to be a larger value than the minimum value if quantum states of the k−1^{th} excited state |eₖ₋₁> or lower were to be included.

L₂(φᵢ) as described above is defined by appending a negative sign to the energy expected value of the Hamiltonian H at |ψₛ(φᵢ)>. When the second parameter φᵢ is changed so as to cause the expected value L₂(φᵢ) to approach the minimum value, the Hamiltonian H energy expected value itself is defined as L₂(φᵢ) without appending the sign, and this is synonymous with changing the second parameter (i so as to approach the maximum value.

The classical computer 110 may, as required, transmit to the user terminal 130 solution information relating to the solution of a problem the user of the user terminal 130 wishes to solve (S310). The solution information may include information relating to the k^{th} excited state, and more specifically, may include the expected value of the Hamiltonian H for the k^{th} excited state. The solution information may also include a measurement result for the k^{th} excited state or information corresponding to thereto.

In the present exemplary embodiment, quantum states are confined in an extensible subspace of k+1 quantum states from out of 2ⁿ mutually orthogonal quantum states that are possible quantum states for a qubit number n by optimizing the first parameter θi, and then optimization is performed of the additional second parameter φᵢ within this subspace. This enables faster excited state production than in the first exemplary embodiment.

### Third Exemplary Embodiment

In a third exemplary embodiment, a Green's function is computed using a method to find the excited states of the Hamiltonian H of either the first exemplary embodiment or the second exemplary embodiment.

A Green's function is a function employed in logical computation and the like. For example, computing a Green's function enables information relating to the phase of a material to be obtained. Equation (A) below is one expression format of a Green's function.

G_{ab}^{R}(t)=−iΘ(t) [symbol] cₐ(t)c_{b}^{†}(0)+c_{b}^{†}(0)cₐ(t) [symbol] ₀ (A)

Wherein: t is a timing; cₐ(⋅) and c_{b}(⋅) are electron operators; and a and b are excitation modes (for example wavenumbers) of an electron; Θ(t) is a Heaviside step function. Moreover, † represents a Hermitian conjugate. Note that in the following explanation, “i” represents the imaginary unit when appearing in a location other than a suffix.

In the third exemplary embodiment, a method to find the excited states of the Hamiltonian H is employed to compute a spectral function for the Green's function. This also enables the Green's function to be computed.

In the third exemplary embodiment, only the imaginary part of a spectral function obtained by performing a Fourier transformation on the Green's function is computed. This is since it is possible to reconstruct the real part of the spectral function using Kramers-Kronig relations as long as a computation result can be obtained for the imaginary part of the spectral function.

The following equation is for a spectral function for the Green's function and is the imaginary part of the spectral function. Note that η is a positive constant. q is a wavenumber. Although a case is described in which the electron excitation modes a, b both have wavenumber q and up-spin ↑, the third exemplary embodiment is similarly applicable to a Green's function related to excitation modes a, b in general.

A_{q}(ω)=−π⁻¹Im\tilde{G}_{q}^{R}(ω). (B)

The hybrid system 100 of the third exemplary embodiment computes an imaginary part A_{q}(ω) of the above spectral function. The imaginary part A_{q}(ω) of the spectral function can be expressed by Equation (C) below. Equation (3) below is a spectral function expressed using the Källen-Lehmann spectral representation.

$${A}_{q} ( ω ) = {\sum }_{n} ( \frac{\text{\textbar} \text{〈} {E}_{n} \text{\textbar} {c}_{q}^{†} \text{\textbar} G \text{〉} {\text{\textbar}}^{2}}{ω + {E}_{G} - {E}_{n} + i η} + \frac{\text{\textbar} \text{〈} {E}_{n} \text{\textbar} {c}_{q} \text{\textbar} G \text{〉} {\text{\textbar}}^{2}}{ω - {E}_{G} + {E}_{n} + i η} ) , \qquad ( C )$$

In Equation (C), E_{G} is the energy of the Hamiltonian H ground state. |G> is a ground state of the Hamiltonian H. Eₙ is an n^{th} eigenvalue of the Hamiltonian H. |Eₙ> is an n^{th} eigenstate of the Hamiltonian H.

The hybrid system 100 of the third exemplary embodiment computes the energy E_{G} of the Hamiltonian H ground state, the n^{th} eigenstate Eₙ of the Hamiltonian H, <Eₙ|c_{q}|G>, and <Eₙ|c_{q}^{†}|G> that appear above in the imaginary part A_{q}(ω) of the spectral function for the Green's function in Equation (C).

Specifically, first the classical computer 110 and the quantum computer 120 of the hybrid system 100 compute the following Equations (D) based on a value θ* satisfying the convergence conditions of the first exemplary embodiment and the second exemplary embodiment. The energy E_{G} of the Hamiltonian H ground state and a given j^{th} eigenvalue Eⱼ of the Hamiltonian H are accordingly computed by computing the following Equations (D). Moreover, by computing the following Equations (D) based on the value θ* satisfying the convergence conditions finds the ground state |G> of the Hamiltonian H and the given j^{th} eigenstate |Eⱼ> of the Hamiltonian H.

E_{G}= [symbol] ψ₀(θ*)|H|ψ₀(θ*) [symbol]
Eⱼ= [symbol] ψⱼ(θ*)|H|ψⱼ(θ*)

[symbol]

|G [symbol] =|ψ₀(θ*)

[symbol]

|Eⱼ [symbol] =|ψⱼ(θ*) [symbol] (D)

Note that in the Källen/Lehmann spectral representation of the spectral function, n in eigenvalue Eₙ of the Hamiltonian H adopts all possible eigenstates. However, the third exemplary embodiment is only able to find eigenstates from the smallest eigenvalues to (k+1).

Note that in cases in which the quantum computer is a system with N qubits, n in eigenvalue Eₙ of the Hamiltonian H adopts any value from 1 to 2^{N}. Since the Hamiltonian H is expressed by a 2^{N}×2^{N} matrix, there are 2^{N} eigenstates available.

Next, the hybrid system 100 computes <Eₙ|c_{q}|G>, and <Eₙ|c_{q}^{†}|G> that appear above in the imaginary part Aq (ω) of the spectral function for the Green's function in Equation (C).

Specifically, the classical computer 110 of the hybrid system 100 transforms the electron operator c_{q} of <Eₙ|c_{q}|G> and the electron operator c_{q}^{†} of <Eₙ|c_{q}^{†}|G> to sums of the Pauli matrices using the Jordan-Wigner transformation as expressed by Equations (E) below. Note that the suffixes q and ↑ represent the wavenumber and spin of an electron.

$${c}_{q , \text{↑}} \text{→} {\sum }_{n = 1}^{Nq} {λ}_{n}^{( q )} {P}_{n} , {c}_{q , \text{↑}}^{†} \text{→} {\sum }_{n = 1}^{Nq} {λ}_{n}^{( q ) *} {P}_{n} , \qquad ( E )$$

Note that kg in Equations (E) represents a coefficient which may be either a real number or a pure imaginary number. Pₙ represents a Pauli matrix. N_{q} represents the total number of states. Hereafter c_{q,↑} is denoted simply as c_{q}, and c^{†}_{q,↑} is denoted simply as c^{†}_{q}.

The classical computer 110 then splits the Pauli matrices sums obtained using Equations (E) into those in which the coefficient kg is a real number and those in which λₙ is an imaginary number.

The classical computer 110 then expresses the sums of the Pauli matrices that have been split into real number and the imaginary number parts in the following format.

c_{q}=α+iβ

c^{†}_{q}=α′+iβ′

In the above Equations, α and β (and α′ and β′) are Hermitian operators, and are observable quantities. Namely, in the present exemplary embodiment, physical quantities that are non-measureable when in the original electron operator format are divided into measurable parts α and β (and α′ and β′).

Next, the classical computer 110 substitutes the electron operator real part and the electron operator imaginary part for a given variable A in Equation (F1) and Equation (F2) below. Specifically, the classical computer 110 substitutes α and β (and α′ and β′) obtained by splitting as above into the Equation (F1) and Equation (F2) below.

$$\begin{matrix}Re ( \text{〈} {ψ}_{i} ( {θ}^{*} ) \text{\textbar} A \text{\textbar} {ψ}_{j} ( {θ}^{*} ) \text{〉} ) = \text{〈} {ψ}_{ij}^{+ x} ( {θ}^{*} ) \text{\textbar} A \text{\textbar} {ψ}_{ij}^{+ x} ( {θ}^{*} ) \text{〉} - \frac{1}{2} \text{〈} {ψ}_{i} ( {θ}^{*} ) \text{\textbar} A \text{\textbar} {ψ}_{i} ( {θ}^{*} ) \text{〉} - \frac{1}{2} \text{〈} {ψ}_{j} ( {θ}^{*} ) \text{\textbar} A \text{\textbar} {ψ}_{j} ( {θ}^{*} ) \text{〉} & ( F 1 ) \\ Im ( \text{〈} {ψ}_{i} ( {θ}^{*} ) \text{\textbar} A \text{\textbar} {ψ}_{j} ( {θ}^{*} ) \text{〉} ) = \text{〈} {ψ}_{ij}^{+ y} ( {θ}^{*} ) \text{\textbar} A \text{\textbar} {ψ}_{ij}^{+ y} ( {θ}^{*} ) \text{〉} - \frac{1}{2} \text{〈} {ψ}_{i} ( {θ}^{*} ) \text{\textbar} A \text{\textbar} {ψ}_{i} ( {θ}^{*} ) \text{〉} - \frac{1}{2} \text{〈} {ψ}_{j} ( {θ}^{*} ) \text{\textbar} A \text{\textbar} {ψ}_{j} ( {θ}^{*} ) \text{〉} \\ \text{\textbar} {ψ}_{ij}^{+ x} ( θ ) \text{>} , \text{\textbar} {ψ}_{ij}^{+ y} ( θ ) \text{>} are defined as follows . \\ \text{\textbar} {ψ}_{ij}^{+ x} ( θ ) \text{〉} = \frac{1}{\sqrt{2}} ( \text{\textbar} {ψ}_{i} ( θ ) \text{〉} + \text{\textbar} {ψ}_{j} ( θ ) \text{〉} ) \\ \text{\textbar} {ψ}_{ij}^{+ y} ( θ ) \text{〉} = \frac{1}{\sqrt{2}} ( \text{\textbar} {ψ}_{i} ( θ ) \text{〉} + i \text{\textbar} {ψ}_{j} ( θ ) \text{〉} ) & ( F 2 )\end{matrix}$$

A in Equation (F1) and Equation (F2) represents a given variable. The classical computer 110 substitutes c_{q}=α+iβ and c^{†}_{q}=α′+iβ′ for A in Equation (F1) and Equation (F2).

The classical computer 110 also substitutes a given i^{th} eigenstate<Eᵢ| of the Hamiltonian H for <ψᵢ(θ*) of <ψᵢ(θ*)|A|ψⱼ(θ*)> on the left side of Equation (F1) and of Equation (F2). The classical computer 110 further substitutes a given j^{th} eigenstate <Eⱼ| of the Hamiltonian H for |ψⱼ(θ*)> on the left side of Equation (F1) and of Equation (F2).

The left sides of Equation (F1) and Equation (F2) thus become <Eᵢ|c_{q}|Eⱼ>. The classical computer 110 sets a given i^{th} eigenvalue Eᵢ of the Hamiltonian H as the n^{th} eigenvalue Eₙ of the Hamiltonian H, and sets a given j^{th} eigenvalue Eⱼ of the Hamiltonian H as the energy E_{G} of the Hamiltonian H ground state. The left side of Equation (F1) and Equation (F2) is accordingly changed from <Eᵢ|c_{q}|Eⱼ> to <Eₙ|c_{q}|G>.

As described above, α+iβ is substitutable for c of <Eₙ|c_{q}|G>, to give <Eₙ|c_{q}|G>=<Eₙ|α|G>+i<Eₙ|β|G>.

The quantum computer 120 performs quantum computation to compute <Eₙ|c_{q}|G> based on the Equation obtained in this manner. Note that <Eₙ|c^{†}_{q}|G> may also be computed by a similar method.

The classical computer 110 then computes Equation (C) above based on the energy E_{G} of the Hamiltonian H ground state, n^{th} eigenvalue Eₙ of the Hamiltonian H, <Eₙ|c_{q}|G>, and <Eₙ|c_{q}^{†}|G> so as to compute the imaginary part A_{q}(ω) of the spectral function for the Green's function. The real part of the spectral function is also computable as long as the imaginary part A_{q}(ω) of the spectral function for the Green's function can be obtained. This enables computation of the Green's function.

Note that when computing the Green's function, the Hamiltonian H, the wavenumber q (or a, b) that is information to specify the electron operator, k representing how many eigenvalues to find, the set of k+1 mutually orthogonal initial states, and the quantum circuit U (θ) are decided using the user terminal 130 or the classical computer 110. The operators α, β, α′, and β′, obtained when split into c_{q} and c_{q† may also be decided by the user terminal 130 or the classical computer 110.}

The quantum computer 120 acquires the set of k+1 mutually orthogonal initial states, the quantum circuit U (θ), and the operators α, β, α′, and β′ obtained when split into c_{q} and c_{q}^{†}, which have been decided by the user terminal 130 or the classical computer 110, and performs quantum computation based thereon.

Note that although in the third exemplary embodiment explanation has been given regarding an example in which there is at least one different coefficient wⱼ out of the plural coefficients wⱼ, there is no limitation thereto. For example, in a case in which all of the plural coefficients wⱼ have the same value, computation of the Green's function may be executed based on the following literature.

R. M. Parrish, E. G. Hohenstein, P. L. McMahon, and T. J. Marttinez, “Quantum Computation of Electronic Transitions Using a Variational Quantum Eigensolver”, Physical Review Letters 122, 230401(2019).

The third exemplary embodiment thus enables the Green's function to be computed employing a method for finding Hamiltonian excited states.

The processing executed by the CPU reading software (a program) in the exemplary embodiments described above may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Moreover, although in the exemplary embodiments described above explanation has been given regarding a mode in which a program is stored (installed) in advance in storage, there is no limitation thereto. A program may be provided in a format stored on a non-transitory storage medium such as compact disk read only memory (CD-ROM), digital versatile disk read only memory (DVD-ROM), or universal serial bus (USB) memory. Alternatively, a program may be configured in a format downloadable from an external device over a network.

The respective processing of the present exemplary embodiments may be performed by a configuration of a computer, server, or the like including a generic computation processing device and storage device, with the respective processing being executed by a program. Such a program may be stored in the storage device, provided recorded on a recording medium such as a magnetic disc, an optical disc, or semiconductor memory, or provided over a network. Obviously any other configuration elements are also not limited to implementation by a single computer or server, and they may be distributed between plural computers connected together over a network and implemented thereon.

Note that the present exemplary embodiments are not limited to the exemplary embodiments described above, and various modifications and applications are possible within a range not departing from the spirit of the respective exemplary embodiments.

The disclosures of Japanese Patent Application No. 2018-207825, filed on Nov. 4, 2018, and Japanese Patent Application No. 2019-130414, filed on Jul. 12, 2019, are incorporated in their entirety in the present specification by reference herein. All cited documents, patent applications, and technical standards mentioned in the present specification are incorporated by reference in the present specification to the same extent as if each individual cited document, patent application, or technical standard was specifically and individually indicated to be incorporated by reference.

### Example

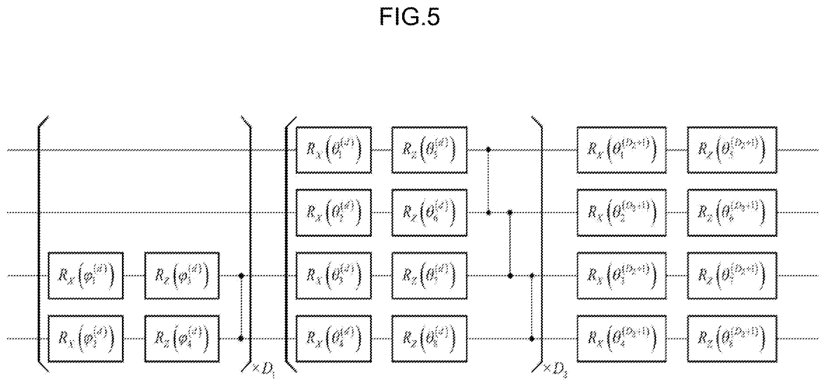

Simulation results are illustrated for a Hamiltonian H with n=4. FIG. 5 illustrates an example for the first quantum circuit U (θ) and the second quantum circuit V (φ) illustrated in FIG. 4, in which parameters D₁ and D₂ indicate the number of repetitions within the respective parentheses, with D₁=2 and D₂=6. The set of initial states was {|0000>, |0001>, |0010>, |00011>}. Initial values of the first parameter θ₁ and the second parameter φ₁ were set to random numbers in a fixed range from 0 up to but not including 2π. The results that gives the lowest value for the cost function from out of the optimizations performed for 10 different initial values are given below. A SciPy library BFGS method was employed in parameter optimization. The excitation order k to find the excited states was set to 3.

The Hamiltonian H that expresses the problem to be solved is represented by the following equation. This is a fully coupled transverse-field Ising model. The coefficients aᵢ and Lᵢⱼ are randomly sampled from a uniform distribution from 0 up to but not including 1. The qubit number n is 4.

$$H = {\sum }_{i = 1}^{n} {a}_{i} {X}_{i} + {\sum }_{i = 1}^{n} {\sum }_{j = 1}^{i - 1} {J}_{ij} {Z}_{i} {Z}_{j}$$

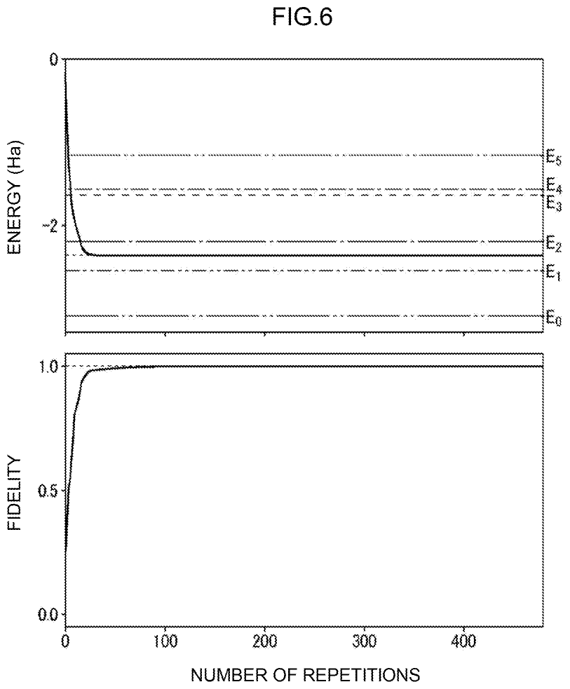

FIG. 6 illustrates an optimization process for the first parameter θ. In FIG. 6, fidelity is defined by the overlap between extensible space defined by {|g>, |e₁>, |e₁>, |e₁>} and the output of the first quantum circuit U (θ). More specifically, fidelity is defined using the following equation, in which for convenience |g> is denoted by e₀>, and in which |ψⱼ(θ)> denotes the quantum state after the first quantum circuit U (θ) has been executed for the j^{th} initial state (wherein j is an integer from 0 to k). It is apparent from FIG. 6 that as expected fidelity approaches 1 as the cost function approaches the minimum value.

$$\frac{1}{4} {\sum }_{i = 0}^{n} {\sum }_{j = 0}^{n} \text{\textbar} \text{〈} {e}_{i} \text{\textbar} {ψ}_{j} ( θ ) \text{〉} {\text{\textbar}}^{2}$$

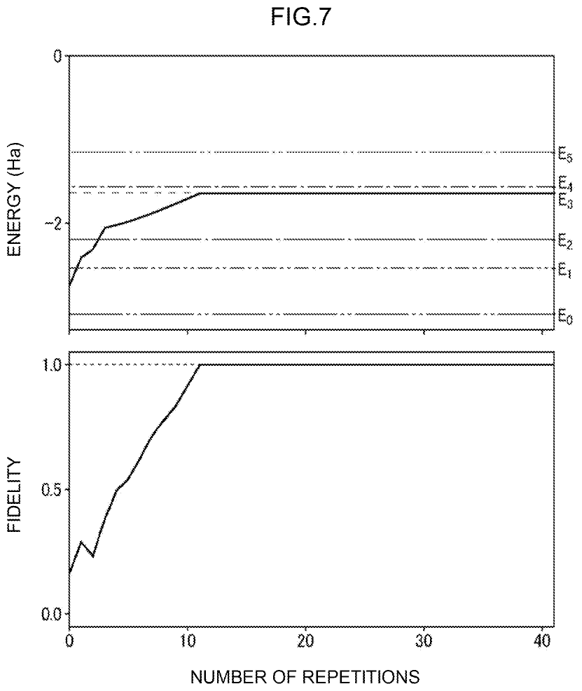

FIG. 7 illustrates an optimization process for the second parameter (p. A quantum computation is executed here for the third initial state |0010>, and fidelity is defined by the following equation. It can be confirmed from FIG. 7 that the energy expected value converges precisely on the value of the third excited state.

| [symbol] eₖ|U(θ*)V(ϕ)|0010 [symbol] |²

In the case of related technology, for example, the method described in the aforementioned literature, such as “Variational Quantum Computation of Excited States”, O. Higgott, D. Wang, and S. Brierley, 2018, arXiv:1805.08138, requires enormous computation time and a large qubit number. There is accordingly a desire to improve the efficiency of computing in a quantum computer.

In consideration of the above circumstances, an object of technology disclosed herein is to achieve more efficient computation in a method and program for finding excited states of a Hamiltonian in a hybrid system, which includes both a quantum computer and a classical computer, and to achieve more efficient computation in the classical computer configuring such a hybrid system.

Aspects of technology disclosed herein enables more efficient computation in a method and program for finding excited states of a Hamiltonian in a hybrid system that includes both a quantum computer and a classical computer by employing properties derived from a set of k+1 initial states, with the initial states required to be mutually orthogonal and decided according to a qubit number n of a Hamiltonian H and an energy excitation level k to be found. The aspects also enable more efficient computation in the classical computer configuring the hybrid system.

A first aspect of technology disclosed herein is a method for finding excited states of a Hamiltonian. The method causing a classical computer to execute a process comprising: deciding a set of k+1 mutually orthogonal initial states for a Hamiltonian H of qubit number n, wherein k is an integer from 0 to 2ⁿ⁻¹, and n is a positive integer; deciding a first quantum circuit U (θ) that is a unitary quantum circuit of qubit number n; deciding a first parameter θᵢ and generating quantum computation information for executing the first quantum circuit U (θᵢ) on a qubit cluster of a quantum computer; storing a computation result of respective quantum computations based on the quantum computation information for each of the set of initial states; computing an expected value sum L₁(θᵢ) of the Hamiltonian H expressed by Equation (1) based on the computation results for the initial states; and changing the first parameter θᵢ in a direction in which the sum approaches a minimum value and storing a value θ* when a convergence condition has been satisfied.

L₁(θᵢ)=Σⱼ₌₀^{k}wⱼ<ψⱼ(θi)|H|ψⱼ(θᵢ)> (1)

Wherein |ψⱼ(θᵢ)> is a quantum state after executing the first quantum circuit (θᵢ) for a j^{th} initial state, and wⱼ is a positive coefficient.

A second aspect of technology disclosed herein is the first aspect, wherein wₛ, which is one of coefficients wⱼ, wherein s is an integer from 0 to k has a smaller value than other of the coefficients wⱼ(when j≠s).

A third aspect of technology disclosed herein is the second aspect, further comprising: transmitting information relating to a quantum state |ψₛ(θ*)> as solution information relating to a k^{th} excited state.

A fourth aspect of technology disclosed herein is the first aspect, wherein the coefficients wⱼ are each the same value.

A fifth aspect of technology disclosed herein is the fourth aspect, further comprising: deciding a second quantum circuit V (φ) that intermingles the set of initial states; deciding a second parameter φᵢ and generating quantum computation information for executing a first quantum circuit U (θ*) and a second quantum circuit V (φᵢ) on a qubit cluster of a quantum computer; storing a computation result of the quantum computation for a given s^{th} initial state from among the set of initial states based on the quantum computation information, wherein s is an integer from 0 to k; computing an expected value L₂(φᵢ) of the Hamiltonian H expressed by Equation (2) based on the computation result for the s^{th} initial state; and changing the second parameter φᵢ in a direction in which the expected value approaches a maximum value and storing a value φ* when a convergence condition has been satisfied.

L₂(ϕᵢ)=<ψₛ(ϕᵢ)|H|ψₛ(ϕᵢ)> (2)

A sixth aspect of technology disclosed herein is the fifth aspect, wherein the second quantum circuit V (φ) operates only on k+1 states of the set of initial states.

A seventh aspect of technology disclosed herein is the fifth aspect or the sixth aspect, further comprising transmitting |ψⱼ(φᵢ)> as a quantum state after the second quantum circuit (φᵢ) has been executed for the j^{th} initial state, and transmitting information relating to |ψₛ(φ*)> as solution information relating to a k^{th} excited state.

An eighth aspect of technology disclosed herein is any one of the first aspect to the seventh aspect, wherein the method is executed by a classical computer connected to the quantum computer over a computer network.

A ninth aspect of technology disclosed herein is any one of the first aspect to the eighth aspect, wherein, when computing: an energy E_{G} of a ground state of the Hamiltonian H, an n^{th} eigenvalue Eₙ of the Hamiltonian H, <Eₙ|c_{q}|G>, wherein |Eₙ> is an n^{th} eigenstate of the Hamiltonian H, |G> is the Hamiltonian H ground state, and c_{q} is an electron operator, and <Eₙ|c_{q}^{†}|G>, wherein † is a Hermitian conjugate, which appear in an imaginary part A_{q}(ω) of a spectral function for a Green's function, wherein q is a wavenumber and ω is a frequency, the method further comprises: using Equation (3) below, computing an energy E_{G} of a ground state of the Hamiltonian H and a given j^{th} eigenvalue Eⱼ of the Hamiltonian H based on the value θ* when the convergence condition was satisfied; splitting the electron operator cₖ into an electron operator real part and an electron operator imaginary part; computing <Eₙ|cₙ|G> and <Eₙ|c_{q}^{†}|G> based on the value θ* when the convergence condition was satisfied by substituting the n^{th} eigenstate <Eₙ| of the Hamiltonian H for <ψᵢ(θ*) of <ψᵢ(θ*)|A|ψⱼ(θ*)> on a left side of Equation (4) below, by substituting the Hamiltonian H ground state G> for ψⱼ(θ*)> of <_{W}, (θ*)|A|ψⱼ(θ*)> on the left side of Equation (4) below, and substituting the electron operator real part and the electron operator imaginary part for a given variable A; and computing the imaginary part Aₙ(w) of the spectral function for the Green's function by computing Equation (5) below based on the Hamiltonian H ground state energy E_{G}, the n^{th} eigenvalue Eₙ of the Hamiltonian H as obtained by setting n for the j of the given j^{th} eigenvalue E_{E} of the Hamiltonian H, <Eₙ|c_{q}|G>, and <Eₙ|c_{q}^{†}|G>

$$\begin{matrix} {E}_{G} = \text{〈} {ψ}_{0} ( {θ}^{*} ) \text{\textbar} H \text{\textbar} {ψ}_{0} ( {θ}^{*} ) \text{〉} \\ {E}_{j} = \text{〈} {ψ}_{j} ( {θ}^{*} ) \text{\textbar} H \text{\textbar} {ψ}_{j} ( {θ}^{*} ) \text{〉} \\ \text{\textbar} G \text{〉} = \text{\textbar} {ψ}_{0} ( {θ}^{*} ) \text{〉} \\ \text{\textbar} {E}_{j} \text{〉} = \text{\textbar} {ψ}_{j} ( {θ}^{*} ) \text{〉} & ( 3 ) \\ Re ( \text{〈} {ψ}_{i} ( {θ}^{*} ) \text{\textbar} A \text{\textbar} {ψ}_{j} ( {θ}^{*} ) \text{〉} ) = \text{〈} {ψ}_{ij}^{+ x} ( {θ}^{*} ) \text{\textbar} A \text{\textbar} {ψ}_{ij}^{+ x} ( {θ}^{*} ) \text{〉} - \frac{1}{2} \text{〈} {ψ}_{i} ( {θ}^{*} ) \text{\textbar} A \text{\textbar} {ψ}_{i} ( {θ}^{*} ) \text{〉} - \frac{1}{2} \text{〈} {ψ}_{j} ( {θ}^{*} ) \text{\textbar} A \text{\textbar} {ψ}_{j} ( {θ}^{*} ) \text{〉} \\ Im ( \text{〈} {ψ}_{i} ( {θ}^{*} ) \text{\textbar} A \text{\textbar} {ψ}_{j} ( {θ}^{*} ) \text{〉} ) = \text{〈} {ψ}_{ij}^{+ y} ( {θ}^{*} ) \text{\textbar} A \text{\textbar} {ψ}_{ij}^{+ y} ( {θ}^{*} ) \text{〉} - \frac{1}{2} \text{〈} {ψ}_{i} ( {θ}^{*} ) \text{\textbar} A \text{\textbar} {ψ}_{i} ( {θ}^{*} ) \text{〉} - \frac{1}{2} \text{〈} {ψ}_{j} ( {θ}^{*} ) \text{\textbar} A \text{\textbar} {ψ}_{j} ( {θ}^{*} ) \text{〉} & ( 4 ) \\ {A}_{q} ( ω ) = {\sum }_{n} ( \frac{\text{\textbar} \text{〈} {E}_{n} \text{\textbar} {c}_{q}^{†} \text{\textbar} G \text{〉} {\text{\textbar}}^{2}}{ω + {E}_{G} - {E}_{n} + i η} + \frac{\text{\textbar} \text{〈} {E}_{n} \text{\textbar} {c}_{q} \text{\textbar} G \text{〉} {\text{\textbar}}^{2}}{ω - {E}_{G} + {E}_{n} + i η} ) & ( 5 )\end{matrix}$$

Wherein |ψ^{+x}ᵢⱼ(θ)> and |ψ^{+y}ᵢⱼ(θ)>, are defined as follows, wherein the symbol “i” represents an imaginary unit when appearing in a location other than a suffix.

$$\text{\textbar} {ψ}_{ij}^{+ x} ( θ ) \text{〉} = \frac{1}{\sqrt{2}} ( \text{\textbar} {ψ}_{i} ( θ ) \text{〉} + \text{\textbar} {ψ}_{j} ( θ ) \text{〉} )$$

$$\text{\textbar} {ψ}_{ij}^{+ x} ( θ ) \text{〉} = \frac{1}{\sqrt{2}} ( \text{\textbar} {ψ}_{i} ( θ ) \text{〉} + \text{\textbar} {ψ}_{j} ( θ ) \text{〉} )$$

A tenth aspect of technology disclosed herein is a non-transitory recording medium storing a program to cause a method for finding excited states of a Hamiltonian to be executed on a classical computer, the method causing the classical computer to execute process comprising: deciding a set of k+1 mutually orthogonal initial states for a Hamiltonian H of qubit number n, wherein k is an integer from 0 to 2ⁿ⁻¹, and n is a positive integer; deciding a first quantum circuit U (θ) that is a unitary quantum circuit of qubit number n; deciding a first parameter θᵢ and generating quantum computation information for executing the first quantum circuit U (θᵢ) on a qubit cluster of a quantum computer; storing a computation result of respective quantum computations based on the quantum computation information for each of the set of initial states; computing an expected value sum L₁(θᵢ) of the Hamiltonian H expressed by Equation (1) based on the computation results for the initial states; and changing the first parameter θᵢ in a direction in which the sum approaches a minimum value and storing a value θ* when a convergence condition has been satisfied.

L₁(θᵢ)=Σⱼ₌₀^{k}wⱼ<ψⱼ(θi)|H|ψⱼ(θᵢ)> (1)

Wherein |ψⱼ(θᵢ)> is a quantum state after executing the first quantum circuit (θᵢ) for a j^{th} initial state, and wᵢ is a positive coefficient.

A eleventh aspect of technology disclosed herein is a classical computer for finding excited states of a Hamiltonian, the classical computer comprising: a memory; and a classical processor coupled to the memory, the processor being configured to perform a process comprising: deciding a set of k+1 mutually orthogonal initial states for a Hamiltonian H of qubit number n, wherein k is an integer from 0 to 2ⁿ⁻¹, and n is a positive integer; deciding a first quantum circuit U (θ) that is a unitary quantum circuit of qubit number n; deciding a first parameter θᵢ and generating quantum computation information for executing the first quantum circuit U (θᵢ) on a qubit cluster of a quantum computer; storing a computation result of respective quantum computations based on the quantum computation information for each of the set of initial states; computing an expected value sum L₁(θᵢ) of the Hamiltonian H expressed by Equation (1) based on the computation results for the initial states; and changing the first parameter θᵢ in a direction in which the sum approaches a minimum value and storing a value θ* when a convergence condition has been satisfied.

L₁(θᵢ)=Σⱼ₌₀^{k}wⱼ<ψⱼ(θi)|H|ψⱼ(θᵢ)> (1)

Wherein |ψⱼ(θᵢ)> is a quantum state after executing the first quantum circuit (θᵢ) for a j^{th} initial state, and wⱼ is a positive coefficient.

A twelfth aspect of technology disclosed herein is a quantum computer for finding excited states of a Hamiltonian, the quantum computer being configured to, based on quantum computation information including a set of k+1 mutually orthogonal initial states for a Hamiltonian H of qubit number n, wherein k is an integer from 0 to 2ⁿ⁻¹, and n is a positive integer, a first quantum circuit U (θ) that is a unitary quantum circuit of qubit number n, and a first parameter θᵢ: execute the first quantum circuit U (θᵢ) on a qubit cluster; and output a computation result of respective quantum computations based on the quantum computation information for each of the set of initial states.

A thirteenth aspect of technology disclosed herein is a hybrid system for finding excited states of a Hamiltonian, the hybrid system including a classical computer of technology disclosed herein and a quantum computer of technology disclosed herein.

What is claimed is:

1. A method for finding excited states of a Hamiltonian, the method causing a classical computer to execute a process comprising:
deciding a set of k+1 mutually orthogonal initial states for a Hamiltonian H of qubit number n, wherein k is an integer from 0 to 2ⁿ⁻¹, and n is a positive integer;
deciding a first quantum circuit U (θ) that is a unitary quantum circuit of qubit number n;
deciding a first parameter θᵢ and generating quantum computation information for executing the first quantum circuit U (θᵢ) on a qubit cluster of a quantum computer;
storing a computation result of respective quantum computations based on the quantum computation information for each of the set of initial states;
computing an expected value sum L₁(θᵢ) of the Hamiltonian H expressed by Equation (1) based on the computation results for the initial states; and
changing the first parameter θᵢ in a direction in which the sum approaches a minimum value and storing a value θ* when a convergence condition has been satisfied
L₁(θᵢ)=Σⱼ₌₀^{k}wⱼ<ψⱼ(θi)|H|ψⱼ(θᵢ)> (1)
wherein |ψⱼ(θᵢ)> is a quantum state after executing the first quantum circuit (θᵢ) for a j^{th} initial state, and wⱼ is a positive coefficient.

2. The method of claim 1, wherein wₛ, which is one of coefficients wⱼ, wherein s is an integer from 0 to k has a smaller value than other of the coefficients wⱼ(when j≠s).

3. The method of claim 2, further comprising:
transmitting information relating to a quantum state |ψₛ(θ*)> as solution information relating to a k^{th} excited state.

4. The method of claim 1, wherein the coefficients wⱼ are each the same value.

5. The method of claim 4, further comprising:
deciding a second quantum circuit V (φ) that intermingles the set of initial states;
deciding a second parameter φᵢ and generating quantum computation information for executing a first quantum circuit U (θ*) and a second quantum circuit V (φᵢ) on a qubit cluster of a quantum computer;
storing a computation result of the quantum computation for a given s^{th} initial state from among the set of initial states based on the quantum computation information, wherein s is an integer from 0 to k;
computing an expected value L₂(φᵢ) of the Hamiltonian H expressed by Equation (2) based on the computation result for the s^{th} initial state; and
changing the second parameter φᵢ in a direction in which the expected value approaches a maximum value and storing a value φ* when a convergence condition has been satisfied
L₂(ϕᵢ)=<ψₛ(ϕᵢ)|H|ψₛ(ϕᵢ)> (2)

6. The method of claim 5, wherein the second quantum circuit V (φ) operates only on k+1 states of the set of initial states.

7. The method of claim 5, further comprising transmitting |ψⱼ(φᵢ)> as a quantum state after the second quantum circuit (φᵢ) has been executed for the j^{th} initial state, and transmitting information relating to |ψₛ(φ*)> as solution information relating to a k^{th} excited state.

8. The method of claim 1, wherein the method is executed by a classical computer connected to the quantum computer over a computer network.

9. The method of claim 1, wherein, when computing:
an energy E_{G} of a ground state of the Hamiltonian H,
an n^{th} eigenvalue Eₙ of the Hamiltonian H,
<Gₙ|c_{q}|G>, wherein |Eₙ> is an n^{th} eigenstate of the Hamiltonian H, |G> is the Hamiltonian H ground state, and c_{q} is an electron operator, and
<Eₙ|c_{q}^{†}|G>, wherein † is a Hermitian conjugate, which appear in an imaginary part A_{q}(ω) of a spectral function for a Green's function, wherein q is a wavenumber and ω is a frequency, the method further comprises:
using Equation (3) below, computing an energy E_{G} of a ground state of the Hamiltonian H and a given j^{th} eigenvalue Eⱼ of the Hamiltonian H based on the value θ* when the convergence condition was satisfied;
splitting the electron operator cₖ into an electron operator real part and an electron operator imaginary part;
computing <Eₙ|cₙ|G> and <Eₙ|c_{q}^{†}|G> based on the value θ* when the convergence condition was satisfied by substituting the n^{th} eigenstate <Eₙ| of the Hamiltonian H for <ψᵢ(θ*) of <ψᵢ(θ*)|A|ψⱼ(θ*)> on a left side of Equation (4) below, by substituting the Hamiltonian H ground state |G> for ψⱼ(θ*)> of <ψᵢ(θ*)|A|ψⱼ(θ*)> on the left side of Equation (4) below, and substituting the electron operator real part and the electron operator imaginary part for a given variable A; and computing the imaginary part A_{q}(ω) of the spectral function for the Green's function by computing Equation (5) below based on the Hamiltonian H ground state energy E_{G}, the n^{th} eigenvalue Eₙ of the Hamiltonian H as obtained by setting n for the j of the given j^{th} eigenvalue Eⱼ of the Hamiltonian H, <Eₙ|cₙ|G>, and <Eₙ|c_{q}^{†}|G>
$$\begin{matrix} {E}_{G} = \text{〈} {ψ}_{0} ( {θ}^{*} ) \text{\textbar} H \text{\textbar} {ψ}_{0} ( {θ}^{*} ) \text{〉} \\ {E}_{j} = \text{〈} {ψ}_{j} ( {θ}^{*} ) \text{\textbar} H \text{\textbar} {ψ}_{j} ( {θ}^{*} ) \text{〉} \\ \text{\textbar} G \text{〉} = \text{\textbar} {ψ}_{0} ( {θ}^{*} ) \text{〉} \\ \text{\textbar} {E}_{j} \text{〉} = \text{\textbar} {ψ}_{j} ( {θ}^{*} ) \text{〉} & ( 3 ) \\ Re ( \text{〈} {ψ}_{i} ( {θ}^{*} ) \text{\textbar} A \text{\textbar} {ψ}_{j} ( {θ}^{*} ) \text{〉} ) = \text{〈} {ψ}_{ij}^{+ x} ( {θ}^{*} ) \text{\textbar} A \text{\textbar} {ψ}_{ij}^{+ x} ( {θ}^{*} ) \text{〉} - \frac{1}{2} \text{〈} {ψ}_{i} ( {θ}^{*} ) \text{\textbar} A \text{\textbar} {ψ}_{i} ( {θ}^{*} ) \text{〉} - \frac{1}{2} \text{〈} {ψ}_{j} ( {θ}^{*} ) \text{\textbar} A \text{\textbar} {ψ}_{j} ( {θ}^{*} ) \text{〉} \\ Im ( \text{〈} {ψ}_{i} ( {θ}^{*} ) \text{\textbar} A \text{\textbar} {ψ}_{j} ( {θ}^{*} ) \text{〉} ) = \text{〈} {ψ}_{ij}^{+ y} ( {θ}^{*} ) \text{\textbar} A \text{\textbar} {ψ}_{ij}^{+ y} ( {θ}^{*} ) \text{〉} - \frac{1}{2} \text{〈} {ψ}_{i} ( {θ}^{*} ) \text{\textbar} A \text{\textbar} {ψ}_{i} ( {θ}^{*} ) \text{〉} - \frac{1}{2} \text{〈} {ψ}_{j} ( {θ}^{*} ) \text{\textbar} A \text{\textbar} {ψ}_{j} ( {θ}^{*} ) \text{〉} & ( 4 ) \\ {A}_{q} ( ω ) = {\sum }_{n} ( \frac{\text{\textbar} \text{〈} {E}_{n} \text{\textbar} {c}_{q}^{†} \text{\textbar} G \text{〉} {\text{\textbar}}^{2}}{ω + {E}_{G} - {E}_{n} + i η} + \frac{\text{\textbar} \text{〈} {E}_{n} \text{\textbar} {c}_{q} \text{\textbar} G \text{〉} {\text{\textbar}}^{2}}{ω - {E}_{G} + {E}_{n} + i η} ) & ( 5 )\end{matrix}$$
wherein |ψ^{+x}ᵢⱼ(θ)> and |ψ^{+y}ᵢⱼ(θ)>, are defined as follows, wherein the symbol “i” represents an imaginary unit when appearing in a location other than a suffix
$$\text{\textbar} {ψ}_{ij}^{+ x} ( θ ) \text{〉} = \frac{1}{\sqrt{2}} ( \text{\textbar} {ψ}_{i} ( θ ) \text{〉} + \text{\textbar} {ψ}_{j} ( θ ) \text{〉} )$$
$$\text{\textbar} {ψ}_{ij}^{+ x} ( θ ) \text{〉} = \frac{1}{\sqrt{2}} ( \text{\textbar} {ψ}_{i} ( θ ) \text{〉} + \text{\textbar} {ψ}_{j} ( θ ) \text{〉} ) .$$

10. A non-transitory recording medium storing a program to cause a method for finding excited states of a Hamiltonian to be executed on a classical computer, the method causing the classical computer to execute process comprising:
deciding a set of k+1 mutually orthogonal initial states for a Hamiltonian H of qubit number n, wherein k is an integer from 0 to 2ⁿ⁻¹, and n is a positive integer;
deciding a first quantum circuit U (θ) that is a unitary quantum circuit of qubit number n;
deciding a first parameter θᵢ and generating quantum computation information for executing the first quantum circuit U (θᵢ) on a qubit cluster of a quantum computer;
storing a computation result of respective quantum computations based on the quantum computation information for each of the set of initial states;
computing an expected value sum L₁(θᵢ) of the Hamiltonian H expressed by Equation (1) based on the computation results for the initial states; and
changing the first parameter θᵢ in a direction in which the sum approaches a minimum value and storing a value θ* when a convergence condition has been satisfied
L₁(θᵢ)=Σⱼ₌₀^{k}wⱼ<ψⱼ(θᵢ)|H|ψⱼ(θᵢ)> (1)
wherein |ψⱼ(θᵢ)> is a quantum state after executing the first quantum circuit (θᵢ) for a j^{th} initial state, and wⱼ is a positive coefficient.

11. A classical computer for finding excited states of a Hamiltonian, the classical computer comprising:
a memory; and
a classical processor coupled to the memory, the processor being configured to perform a process comprising:
deciding a set of k+1 mutually orthogonal initial states for a Hamiltonian H of qubit number n, wherein k is an integer from 0 to 2ⁿ⁻¹, and n is a positive integer;
deciding a first quantum circuit U (θ) that is a unitary quantum circuit of qubit number n;
deciding a first parameter θᵢ and generating quantum computation information for executing the first quantum circuit U (θᵢ) on a qubit cluster of a quantum computer;
storing a computation result of respective quantum computations based on the quantum computation information for each of the set of initial states;
computing an expected value sum L₁(θᵢ) of the Hamiltonian H expressed by Equation (1) based on the computation results for the initial states; and
changing the first parameter θᵢ in a direction in which the sum approaches a minimum value and storing a value θ* when a convergence condition has been satisfied
L₁(θᵢ)=Σⱼ₌₀^{k}wⱼ<ψⱼ(θi)|H|ψⱼ(θᵢ)> (1)
wherein |ψⱼ(θᵢ)> is a quantum state after executing the first quantum circuit (θᵢ) for a j^{th} initial state, and wⱼ is a positive coefficient.

12. A quantum computer for finding excited states of a Hamiltonian, the quantum computer being configured to, based on quantum computation information including
a set of k+1 mutually orthogonal initial states for a Hamiltonian H of qubit number n, wherein k is an integer from 0 to 2ⁿ⁻¹, and n is a positive integer,
a first quantum circuit U (θ) that is a unitary quantum circuit of qubit number n, and
a first parameter θᵢ:
execute the first quantum circuit U (θᵢ) on a qubit cluster; and
output a computation result of respective quantum computations based on the quantum computation information for each of the set of initial states.

13. A hybrid system for finding excited states of a Hamiltonian, the hybrid system comprising:
the classical computer of claim 11; and
the quantum computer of claim 12.
